(19) United States
(12) Patent Application Publication
(10) Pub. No.: US 2017/0169611 A1
(43) Pub. Date: Jun. 15, 2017

(54) AUGMENTED REALITY WORKSPACE TRANSITIONS BASED ON CONTEXTUAL ENVIRONMENT

(71) Applicant: Lenovo (Singapore) Pte. Ltd., Singapore (SG)

(72) Inventors: Axel Ramirez Flores, Cary, NC (US); Russell Speight VanBlon, Raleigh, NC (US); Justin Tyler Dubs, Raleigh, NC (US); Robert James Kapinos, Durham, NC (US)

(21) Appl. No.: 14/964,322

(22) Filed: Dec. 9, 2015

(51) Int. Cl. G06T 19/00; A63F 13/26; A63B 22/06; A63B 71/06; G06T 19/20; B62J 99/00

(52) U.S. Cl. CPC G06T 19/006; G06T 19/20; B62J 99/00; A63B 22/0605; A63B 71/0619; A63F 13/26; B62J 2099/0033; A63B 2071/0666

(57) ABSTRACT

One embodiment provides a method, including: receiving, at a head mounted display, data indicating a contextual environment; identifying, using a processor, the contextual environment using the data; and altering, using a processor, data displayed by the head mounted display based on the contextual environment identified, the altered data comprising one or more virtual objects. Other aspects are described and claimed.

### BACKGROUND

Augmented reality devices, e.g., head mounted displays used for augmented reality, provide a user with enhanced display and interactive capabilities. Typically, a head mounted display augments the user's view with virtual objects, e.g., application data, displayed animations, executable icons, etc. These virtual objects are designed to enhance the user's experience to what has been termed “augmented reality.” One or more sensors allow a user to provide inputs, e.g., gesture inputs, voice inputs, etc., to interact with the displayed virtual objects in a workspace.

Existing augmented reality systems (devices and software) rely on the user to provide inputs in order to implement or utilize a given functionality. By way of example, in order for a user to bring up a communication workspace, including for example a video communication application, a user must provide input that indicates this particular functionality is desired in order to configure the augmented reality workspace. Likewise, if a user wishes to compose a drawing by providing gestures, the user must initiate a drawing capability is needed via appropriate input. Existing solutions thus have no concept of contextually aware workspaces and virtual objects or items that should be present in a given augmented reality environment.

### BRIEF SUMMARY

In summary, one aspect provides a method, comprising: receiving, at a head mounted display, data indicating a contextual environment; identifying, using a processor, the contextual environment using the data; and altering, using a processor, data displayed by the head mounted display based on the contextual environment identified, the altered data comprising one or more virtual objects.

Another aspect provides a device, comprising: a head mount; a display coupled to the head mount; a processor operatively coupled to the display; a memory storing instructions executable by the processor to: receive data indicating a contextual environment; identify the contextual environment using the data; and alter data displayed by the display based on the contextual environment identified, the altered data comprising one or more virtual objects.

A further aspect provides a system, comprising: a plurality of sensors; a head mount; a display coupled to the head mount; a processor operatively coupled to the display; a memory storing instructions executable by the processor to: receive, from one or more of the plurality of sensors, data indicating a contextual environment; identify the contextual environment using the data; and alter data displayed by the display based on the contextual environment identified, the altered data comprising one or more virtual objects.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example of providing an augmented reality workspace that transitions based on contextual environment.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As existing solutions have no concept of contextually aware workspaces and virtual items or objects suited for a particular augmented reality environment, an embodiment automatically determines a contextual environment in which the device (e.g., head mounted display device) currently operates. A contextual environment is a current use context (e.g., indoor physical activity, outdoor physical activity, indoor gaming, indoor work environment, outdoor work environment, at-home non-work environment, traveling environment, social media environment, pattern of behavior, etc.). An embodiment automatically (or via use of user input) tags or associates virtual objects or items (these terms are used interchangeably herein) to a defined workspace in an augmented reality environment. Defined workspaces may be automatically implemented, i.e., particular virtual objects are displayed, particular functionality is enabled, etc., based on a contextual environment being detected.

For example, an embodiment may detect that the user is at work or playing a game or at an airport, with an embodiment using each different contextual environment detection as a trigger to automatically retrieve and implement a customized workspace, e.g., display certain virtual objects appropriate for the detected contextual environment. The virtual objects and other characteristics of a workspace appropriate for each contextual environment may be identified by a default rule, by prior user input (e.g., manual tagging, as described herein) or a combination of the foregoing. A benefit of such an approach over existing solutions is to bring added convenience to the end user by quickly bringing to view virtual items relevant to a defined workspace and contextual situation.

Virtual items may be tagged automatically by contextually correlating types of virtual objects used together or in sequence of each other (e.g., riding a bike, video recording the ride, showing heart rate virtual object during the ride, etc.). Automatic contextual detection data can come from sensor data, whether attached to the augmented reality device or from remote sensor(s), or both; likewise, other data sources communicating with the augmented reality device may provide data used to determine a contextual environment. Examples of sensors and data sources include but are not limited to a GPS system, a camera, an accelerometer, a gyroscope, a microphone, an anemometer, and an infrared thermometer, among others.

Virtual items may be tagged manually by a selection gesture or via other user action. Virtual items tagged to a defined workspace (e.g., role playing game (RPG) workspace, biking workspace, etc.) will appear when the user next invokes the defined workspace (e.g., RPG, biking, etc.). For example, if a user created a “biking” workspace and an “RPG gaming” workspace, the “biking” workspace may contain displayed virtual objects such as map application data, speedometer application data, a camera application, and heart rate monitor data. These virtual items may define the biking workspace view. If a user created an “RPG gaming” workspace, such workspace may contain in view an RPG game (displayed data thereof), a screen capture or video recording executable object, and a browser object.

The illustrated example embodiments will be best understood by reference to the figures. The following description is intended only by way of example, and simply illustrates certain example embodiments.

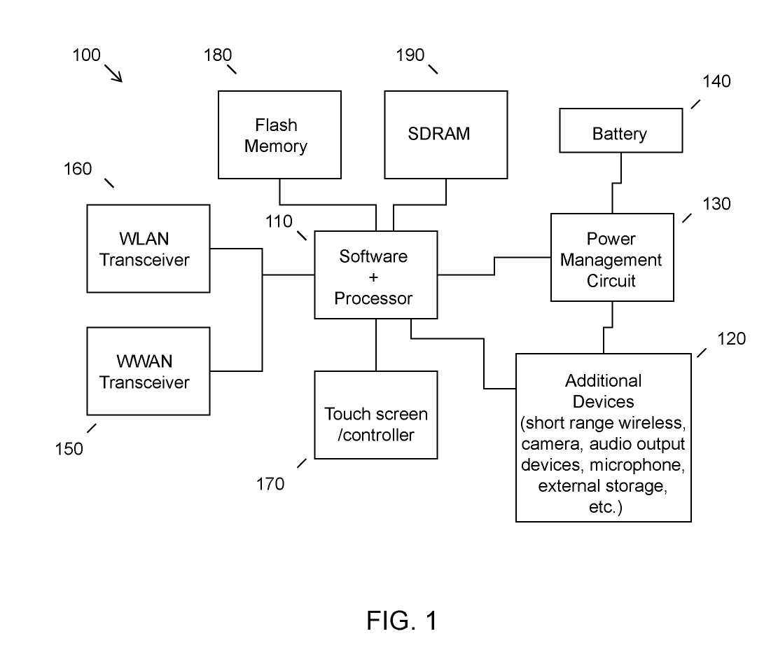

While various other circuits, circuitry or components may be utilized in information handling devices, with regard to wearable devices such as a head mounted display or other small mobile platforms, e.g., a smart phone and/or tablet circuitry 100, an example illustrated in FIG. 1 includes a system on a chip design found for example in tablet, wearable devices, or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a wireless wide area network (WWAN) transceiver 150 and a wireless local area network (WLAN) transceiver 160 for connecting to various networks, such as telecommunications networks (WAN) and wireless Internet devices, e.g., access points offering a Wi-Fi® connection. Additionally, devices 120 are commonly included, e.g., short range wireless communication devices, such as a BLUETOOTH radio, a BLUETOOTH LE radio, a near field communication device, etc., for communicating wirelessly with nearby devices, as further described herein. System 100 often includes a touch screen 170 for data input and display/rendering, which may be modified to include a head mounted display device that provides two or three dimensional display objects, e.g., virtual objects as described herein. A camera may be included as an additional device 120, for example for detecting user gesture inputs, capturing images (pictures, video), etc. System 100 also typically includes various memory devices, for example flash memory 180 and SDRAM 190.

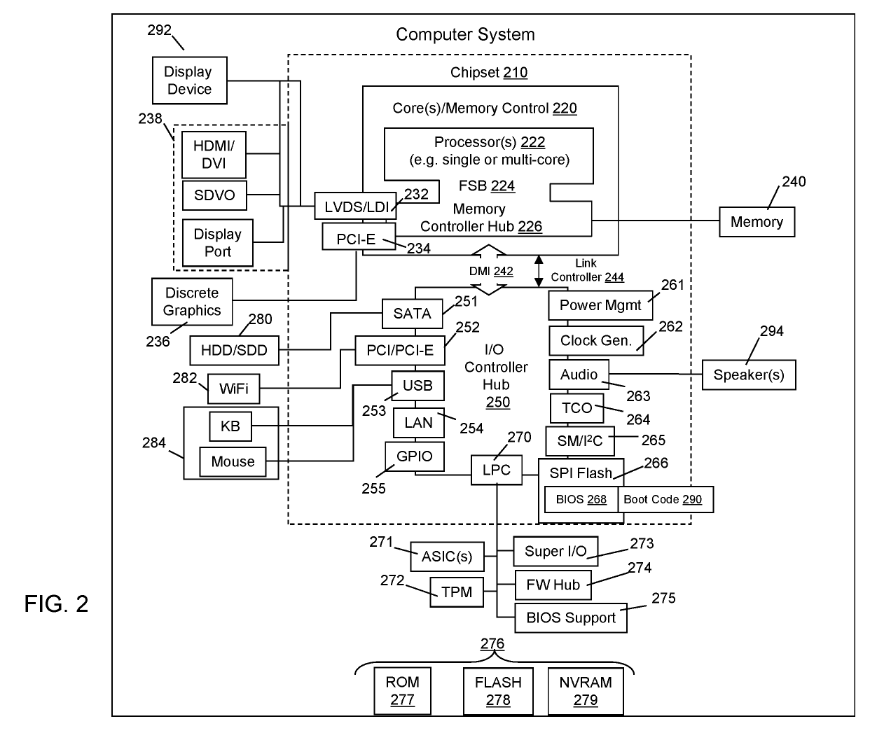

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices or systems of devices providing an augmented reality experience for the user. By way of non-limiting example, the circuitry outlined in FIG. 1 may be included in a head mounted display, whereas the circuitry outlined in FIG. 2 may be used in a personal computer device with which a head mounted display communicates.

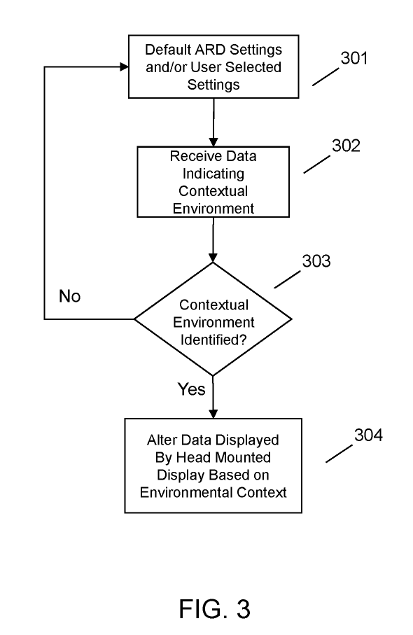

Referring to FIG. 3, an example of providing an augmented reality workspace contextual environment transitions is illustrated. In an augmented reality device, e.g., head mounted display and associated processor(s) and hardware, a default display is provided, e.g., a workspace having virtual objects displayed based on a default suite or set of functionality provided by the augmented reality device. Thus, as illustrated, default augmented reality device settings (ARD settings in FIG. 3) and/or user selected settings (i.e., manual changes to the default display) are provided at 301. In existing systems, the user is required to provide some context to change the display settings, i.e., provide input to bring different, more or fewer virtual objects or items into view in order to change or customize the workspace.

In contrast, an embodiment automatically determines a contextual environment and adjusts or transitions the workspace, e.g., by adjusting virtual objects presented in the workspace view based on the determined contextual environment. For example, an embodiment receives, at the head mounted display, data indicating a contextual environment at 302. This may comprise a variety of different data that likewise may be received in a variety of different ways. For example, an embodiment may receive data from one or more on board sensors that provide data indicative of the contextual environment. The one or more sensors may be physically coupled to the head mounted display. As a specific example, an on-board accelerometer may provide motion data to indicate that the contextual environment includes movement, an onboard GPS sensor may obtain location data from a GPS system to indicate that the device is in a particular geographic location, on-board light and temperature sensors may provide data indicating that the device is outside, an on-board speedometer application may provide data to indicate that the device is moving at a particular speed, etc. The data indicating the contextual environment may likewise be obtained from a remote device, e.g., another wearable device having sensors that is in communication with the head mounted display, a laptop or other personal electronic device that is in communication with the head mounted display, etc.

The various data indicating a contextual environment is then used to identify a contextual environment, i.e., to identify a known use context. Thus, an embodiment may take the above example data input(s) and process the same in order to identify a bike riding contextual environment. If a contextual environment is identified at 303, an embodiment alters data displayed by the head mounted display based on the contextual environment identified at 304. Thus, if a bike riding contextual environment has been identified at 303, an embodiment automatically alters the existing (e.g., default) workspace view to include one or more virtual objects associated with bike riding.

The altering implemented at 304 may include displaying a predetermined set of virtual objects matched to the contextual environment identified. For example, a user may have previously created a biking workspace that contains virtual objects such as map application data, speedometer application data, a camera application, and heart rate monitor data. These virtual objects may be displayed automatically for the user at 304. Likewise, if the contextual environment identified at 303 is an RPG environment, as determined for example via communication between the head mounted display and a nearby gaming console, the altering at 304 may include displaying a screen capture or video recording executable object and a browser object in addition to game application data. Thus, when a contextual environment is identified, a user need not provide manual or other inputs to customize the workspace. If there is no contextual environment identified at 303, the previous or default workspace may be used, as illustrated.

The concept of a contextual environment is not limited to a particular detected physical environment (e.g., outdoor versus indoor, work versus home, etc.). Rather, a contextual environment may be related to a sequence of tasks or other pattern of behavior, for example as learned via storing and consulting a user history. By way of specific example, the contextual environment identified at 303 may include identification of a series or pattern of known behaviors such as opening a specific music playlist and bringing up a hear rate monitoring or other fitness application. In such a case, the contextual environment identified at 303 may include this pattern, and the altering of the displayed workspace at 304 may include a known next action, e.g., adding to the display or removing from the display a virtual object based on the identified sequence or pattern. As a specific example, an embodiment may remove a communication virtual object and display a camera virtual object in response to detecting such a pattern. This again may be based on a learned history (e.g., that the user typically takes pictures or video during fitness activities but does not use a text communication application) and/or based on a general rule (e.g., users generally take pictures or video during fitness activities but do not use a text communication application).

The virtual objects displayed in a workspace are diverse. For example, the one or more virtual objects may include application icons, application generated data, an application functionality (e.g., enabling gesture input, enabling voice input, etc.) or a combination thereof.

As has been described here, an embodiment provides a user with the opportunity to save particular workspaces (inclusive of virtual objects) and associate the same with a given contextual environment (e.g., home environment, work environment, evening environment, pattern of using related applications or functions, etc.). For example, an embodiment may detect user input tagging a virtual object to a current contextual environment and store an association between the virtual object and the contextual environment. This permits an embodiment to detect the contextual environment and automatically alter the displayed workspace by retrieving and displaying the previously tagged virtual object.

An embodiment therefore improves the usability of an augmented reality device itself by facilitating transitions between different workspaces based on a detected contextual environment. This reduces the required user input needed to customize the virtual reality workspace. For users that are new to such devices or unaccustomed to providing certain inputs (e.g., gestures or voice inputs as opposed to conventional keyboard or touch screen inputs), such automation of settings greatly eases the burden on the user in terms of realizing the capabilities of the augmented reality device.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, electromagnetic, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), a portable compact disc read-only memory (CD-ROM), a magnetic storage device, or any suitable combination of the foregoing. In the context of this document, a storage device is not a signal and “non-transitory” includes all media except signal media.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
receiving, at a head mounted display, data indicating a contextual environment;
identifying, using a processor, the contextual environment using the data; and
altering, using a processor, data displayed by the head mounted display based on the contextual environment identified, the altered data comprising one or more virtual objects.

2. The method of claim 1, wherein said altering comprises displaying a predetermined set of virtual objects matched to the contextual environment identified.

3. The method of claim 1, wherein said altering comprises adding a virtual object to the display based on the contextual environment identified.

4. The method of claim 1, wherein said altering comprises removing a virtual object from the display based on the contextual environment identified.

5. The method of claim 1, wherein the one or more virtual objects comprise application generated data.

6. The method of claim 1, wherein said receiving comprises receiving data from one or more sensors.

7. The method of claim 6, wherein at least one of the one or more sensors is physically coupled to the head mounted display.

8. The method of claim 1, further comprising:
detecting user input tagging a virtual object to the contextual environment; and
storing an association between the virtual object and the contextual environment.

9. The method of claim 8, wherein said altering comprises retrieving and displaying a previously tagged virtual object based on the user input.

10. The method of claim 1, wherein:
the contextual environment is biking; and
the display comprises two or more of a map virtual object, a speed virtual object, a camera virtual object, and a fitness virtual object.

11. A device, comprising:
a head mount;
a display coupled to the head mount;
a processor operatively coupled to the display;
a memory storing instructions executable by the processor to:
receive data indicating a contextual environment;
identify the contextual environment using the data; and
alter data displayed by the display based on the contextual environment identified, the altered data comprising one or more virtual objects.

12. The device of claim 11, wherein to alter comprises displaying a predetermined set of virtual objects matched to the contextual environment identified.

13. The device of claim 11, wherein to alter comprises adding a virtual object to the display based on the contextual environment identified.

14. The device of claim 11, wherein to alter comprises removing a virtual object from the display based on the contextual environment identified.

15. The device of claim 11, wherein the one or more virtual objects comprise application generated data.

16. The device of claim 11, wherein to receive comprises receiving data from one or more sensors.

17. The device of claim 16, wherein the device comprises at least one of the one or more sensors.

18. The device of claim 11, wherein the instructions are further executable by the processor to:
detect user input tagging a virtual object to the contextual environment; and
store an association between the virtual object and the contextual environment.

19. The device of claim 18, wherein to alter comprises retrieving and displaying a previously tagged virtual object based on the user input.

20. A system, comprising:
a plurality of sensors;
a head mount;
a display coupled to the head mount;
a processor operatively coupled to the display;
a memory storing instructions executable by the processor to:
receive, from one or more of the plurality of sensors, data indicating a contextual environment;
identify the contextual environment using the data; and
alter data displayed by the display based on the contextual environment identified, the altered data comprising one or more virtual objects.
